(19) United States
(12) Patent Application Publication
(10) Pub. No.: US 2015/0161404 A1
(43) Pub. Date: Jun. 11, 2015

(54) DEVICE INITIATED AUTO FREEZE LOCK

(71) Applicants: Barrett N. Mayes, Bellevue, WA (US); Svanhild M. Salmons, Folsom, CA (US); Darren D. Lasko, Forest, VA (US); Unnikrishnan P. Jayakumar, Folsom, CA (US)

(72) Inventors: Barrett N. Mayes, Bellevue, WA (US); Svanhild M. Salmons, Folsom, CA (US); Darren D. Lasko, Forest, VA (US); Unnikrishnan P. Jayakumar, Folsom, CA (US)

(21) Appl. No.: 14/098,978

(22) Filed: Dec. 6, 2013

(51) Int. Cl. G06F 21/62

(52) U.S. Cl. CPC G06F 21/62

(57) ABSTRACT

In an embodiment, device processing logic associated with a storage device determines whether the storage device should automatically enter a frozen security state. The determination may be made based on one or more criteria associated with the storage device. The criteria may include, for example, expiration of a timer, receiving a command, receiving a predefined type of command, receiving a predefined type of command sequence, not receiving a predefined type of command, and/or not receiving a command sequence. If the criteria is met, the device processing logic may automatically place the storage device into a frozen security state. After being placed in the frozen security state, the storage device may decline processing subsequently received security-related commands.

### BACKGROUND

A computing device may use one or more storage systems to store information. The information may include, for example, data and/or executable instructions. The storage systems may include a primary storage and a secondary storage. A primary storage may be a storage that is directly accessible to a processor that may be contained in the computing device. The processor may access the primary storage via a memory bus that may contain provisions for transferring information between the processor and the primary storage. A secondary storage may be a storage that may not be directly accessible to the processor. Here, information may be transferred between the processor and the secondary storage via one or more input/output (I/O) channels that may be part of an I/O bus.

### BRIEF DESCRIPTION OF THE DRAWINGS

The accompanying drawings, which are incorporated in and constitute a part of this specification, illustrate one or more embodiments described herein and, together with the description, explain these embodiments. In the drawings:

FIG. 1 illustrates a block diagram of an example embodiment of a computing device;

FIG. 2 illustrates an example embodiment of a storage device that may be contained in a secondary storage associated with a computing device; and

FIG. 3 illustrates a flow diagram of example acts that may be performed by a storage device to automatically freeze lock the storage device.

### DETAILED DESCRIPTION

The following detailed description refers to the accompanying drawings. The same reference numbers in different drawings may identify the same or similar elements. Also, the following detailed description does not limit the invention.

A computing device may include a processor and a storage device. The processor may use the storage device to store information that is to survive after power is lost to the computing device. The information may include, for example, data and/or computer-executable instructions.

For example, a computing device such as, for example, a smart phone, tablet, or ultrabook may contain a processor and a storage device such as, for example, a solid-state disk (SSD), hard disk drive, or a thumb drive. The storage device may provide a non-volatile storage for the computing device. The processor may use the storage device to store information for the computing device that is to persist after power is lost to the computing device. The information may include, for example, data and/or applications that may be used by the computing device. The processor may retrieve the persisted information from the storage device after power is restored to the computing device.

A storage device may include control logic which may, inter alia, provide support for various security-related commands associated with the storage device. The security-related commands may be used to implement various security-related features associated with the storage device.

For example, “Information technology—AT Attachment 8-ATA/ATAPI Command Set (ATA8-ACS)”, Working Draft Project American National Standard T13/1699-D, Revision 6, Jun. 24, 2008 (herein “ATA standard”) includes definitions for various security-related commands that may be used to invoke various security-related features associated with a storage device. These commands include a SECURITY SET PASSWORD command which may be used to associate a password with a storage device. The password may be used to control access to the storage device. In other words, the SECURITY SET PASSWORD command may be used to password protect a storage device.

For example, suppose a computing device includes a processor and a storage device. Now suppose the processor issues a SECURITY SET PASSWORD command along with a password to password protect the storage device. Access to the storage device may be restricted until the password is provided.

In addition, the security-related commands supported by the storage control logic may be wrapped within other commands for transport to/from the storage control logic. For example, the well-known Small Component System Interface (SCSI) standard defines a SECURITY PROTOCOL OUT command. A SECURITY SET PASSWORD command may be wrapped within a SECURITY PROTOCOL OUT command for transport to the storage device via a SCSI interface.

As another example, the SECURITY SET PASSWORD command may be wrapped within a SECURITY SEND command for transport to the storage device via a Peripheral Component Interface Express (PCIe) interface utilizing the Non-volatile Memory Express (NVMe) protocol. The SECURITY SEND command is defined in the “NVM Express” specification, Revision 1.0e, Jan. 23, 2013, available from the NVM Work Group (herein “NVMe specification”).

Security-related features supported by a storage device may include provisions for locking the storage device from further processing security-related commands. These provisions may be referred to as a “freeze lock”. A storage device that has been freeze locked may be referred to as being in a frozen security state. While in a frozen security state, the storage device may decline processing some or all security-related commands. The storage device may remain in the frozen security state until a particular event occurs.

For example, the ATA standard also includes a definition for a SECURITY FREEZE LOCK command that may be used to direct a storage device to enter a frozen security state. While in the frozen security state, the storage device may no longer process security-related commands such as, for example, the above-described SECURITY SET PASSWORD command. The storage device may stay in the frozen security state until an event, such as for example the storage device is reset or power cycled, occurs.

A problem may arise when an unauthorized password is associated with a storage device before the storage device is placed in a frozen security state. For example, suppose a computing device includes a processor and a storage device. Further suppose that the storage device supports the above-described SECURITY SET PASSWORD and SECURITY FREEZE LOCK commands.

Now suppose the processor does not issue a SECURITY FREEZE LOCK command to the non-volatile storage device. Since the non-volatile storage device is not in frozen security state, the storage device may still process security-related commands. This may make the storage device vulnerable to an attack by an unauthorized program (e.g., malware) executing on the processor.

For example, an unauthorized program may “hijack” the storage device by issuing a SECURITY SET PASSWORD command to the storage device to associate the storage device with an unauthorized password. The storage device may then be held “hostage” and made inaccessible until the password is provided.

Techniques described herein may obviate situations where, for example, a storage device may be made inaccessible by unauthorized means (e.g., hijacked). The techniques may include, for example, determining whether the storage device has entered a frozen security state; if the storage device has not entered the frozen security state, determining whether certain criteria is met; and if the criteria is met, automatically placing the storage device in a frozen security state. The acts may be performed by control logic that may be contained, for example, within the storage device, thereby enabling the storage device to enter the frozen security state autonomously and without outside intervention.

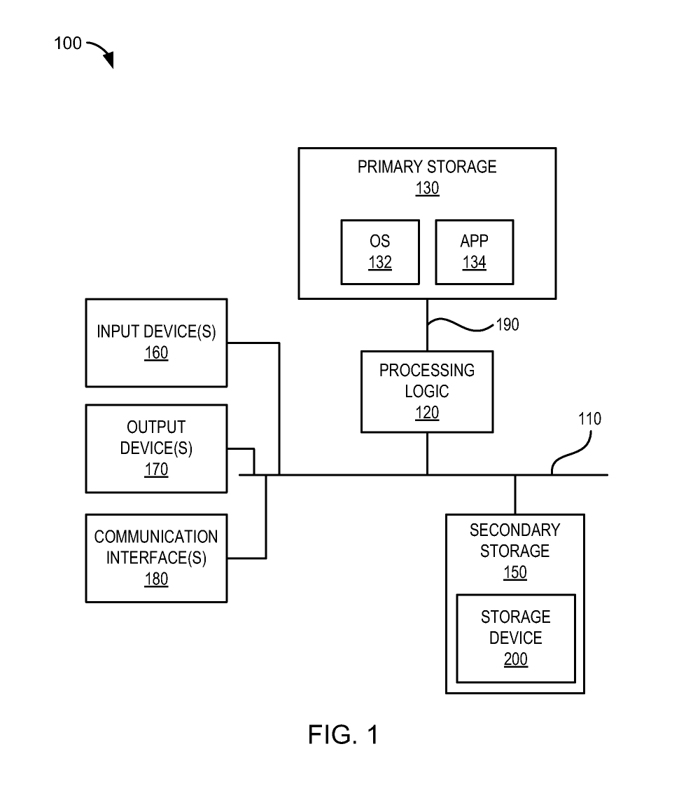

FIG. 1 illustrates a block diagram of an example embodiment of a computing device 100. Referring to FIG. 1, computing device 100 may include various components such as, for example, processing logic 120, primary storage 130, secondary storage 150, one or more input devices 160, one or more output devices 170, and one or more communication interfaces 180.

It should be noted that FIG. 1 illustrates an example embodiment of computing device 100. Other embodiments of computing device 100 may include more components or fewer components than the components illustrated in FIG. 1. Further, the components may be arranged differently than as illustrated in FIG. 1. For example, in an embodiment of computing device 100, a portion of secondary storage 150 may be contained at a remote site that provides “cloud” storage. The site may be accessible to computing device 100 via a communications network, such as, for example, the Internet. A communication interface 180 may be used to interface the computing device 100 with the communications network.

Also, it should be noted that functions performed by various components contained in other embodiments of computing device 100 may be distributed among the components differently than as described herein.

Computing device 100 may include an input/output (I/O) bus 110 that may enable communication among components in computing device 100, such as, for example, processing logic 120, secondary storage 150, one or more input devices 160, one or more output devices 170, and one or more communication interfaces 180. The communication may include, among other things, transferring, for example, control signals and/or data between the components. I/O busses that may be used to implement I/O bus 110 may include, for example, serial AT attachment (SATA), peripheral component interconnect (PCI), PCI express (PCI-e), universal serial bus (USB), small computer system interface (SCSI), serial attached SCSI (SAS), or some other I/O bus.

Computing device 100 may include a memory bus 190 that may enable information, which may be stored in primary storage 130, to be transferred between processing logic 120 and primary storage 130. The information may include computer-executable instructions and/or data that may be executed, manipulated, and/or otherwise processed by processing logic 120.

Processing logic 120 may include logic for interpreting, executing, and/or otherwise processing information. The information may include information that may be stored in, for example, primary storage 130 and/or secondary storage 150. In addition, the information may include information that may be acquired (e.g., read, received) by one or more input devices 160 and/or communication interfaces 180.

Processing logic 120 may include a variety of heterogeneous hardware. For example, the hardware may include some combination of one or more processors, microprocessors, field programmable gate arrays (FPGAs), application specific instruction set processors (ASIPs), application specific integrated circuits (ASICs), complex programmable logic devices (CPLDs), graphics processing units (GPUs), and/or other types of processing logic that may, for example, interpret, execute, manipulate, and/or otherwise process the information. Processing logic 120 may comprise a single core or multiple cores. Examples of processors that may be used to implement processing logic 120 include, but are not limited to, the Intel® Xeon® processor and Intel® Atom™ brand processors which are available from Intel Corporation, Santa Clara, Calif.

Input devices 160 may include one or more devices that may be used to input information into computing device 100. The devices may include, for example, a keyboard, computer mouse, microphone, camera, trackball, gyroscopic device (e.g., gyroscope), mini-mouse, touch pad, stylus, graphics tablet, touch screen, joystick (isotonic or isometric), pointing stick, accelerometer, palm mouse, foot mouse, puck, eyeball controlled device, finger mouse, light pen, light gun, neural device, eye tracking device, steering wheel, yoke, jog dial, space ball, directional pad, dance pad, soap mouse, haptic device, tactile device, neural device, multipoint input device, discrete pointing device, and/or some other input device. The information may include spatial (e.g., continuous, multi-dimensional) data that may be input into computing device 100 using, for example, a pointing device, such as a computer mouse. The information may also include other forms of data, such as, for example, text that may be input using a keyboard.

Output devices 170 may include one or more devices that may output information from computing device 100. The devices may include, for example, a cathode ray tube (CRT), plasma display device, light-emitting diode (LED) display device, liquid crystal display (LCD) device, vacuum florescent display (VFD) device, surface-conduction electron-emitter display (SED) device, field emission display (FED) device, haptic device, tactile device, printer, speaker, video projector, volumetric display device, plotter, touch screen, and/or some other output device. Output devices 170 may be directed by, for example, processing logic 120, to output the information from computing device 100. Outputting the information may include presenting (e.g., displaying, printing) the information on an output device 170. The information may include, for example, text, graphical user interface (GUI) elements (e.g., windows, widgets, and/or other GUI elements), audio (e.g., music, sounds), and/or other information that may be outputted by output devices 170.

Communication interfaces 180 may include logic for interfacing computing device 100 with, for example, one or more communications networks and enable computing device 100 to communicate with one or more entities (e.g., nodes) coupled to the communications networks. The communications networks may include, for example, the Internet, wide-area networks (WANs), local area networks (LANs), 3G and/or 4G networks. Communication interfaces 180 may include one or more transceiver-like mechanisms that may enable computing device 100 to communicate with entities coupled to the communications networks. Examples of communication interfaces 180 may include a built-in network adapter, network interface card (NIC), Personal Computer Memory Card International Association (PCMCIA) network card, card bus network adapter, wireless network adapter, Universal Serial Bus (USB) network adapter, modem, and/or other device suitable for interfacing computing device 100 to a communications network.

Primary storage 130 and secondary storage 150 may include one or memory devices. A memory device may support, for example, serial or random access to information contained in the memory device. A memory device that supports serial access to information stored in the memory device may be referred to as a serial memory device. A memory device that supports random access to information stored in the memory device may be referred to as a random access memory (RAM) device.

A memory device may be, for example, a volatile or non-volatile memory device. A volatile memory device may be a memory device that may lose information stored in the device when power is removed from the device. A non-volatile memory device may be a memory device that may retain information stored in the device when power is removed from the device. Examples of memory devices may include dynamic RAM (DRAM) devices, flash memory devices, static RAM (SRAM) devices, zero-capacitor RAM (ZRAM) devices, twin transistor RAM (TTRAM) devices, read-only memory (ROM) devices, ferroelectric transistor RAM (FeTRAM) devices, magneto-resistive RAM (MRAM) devices, phase change memory (PCM) devices, PCM and switch (PCMS) devices, nanowire-based devices, resistive RAM devices (RRAM), serial electrically erasable programmable ROM (SEEPROM) devices, serial flash devices, and/or other types of memory devices.

Primary storage 130 may be accessible to processing logic 120 via memory bus 190. Primary storage 130 may store computer-executable instructions and/or data that may implement operating system (OS) 132 and application (APP) 134. The computer-executable instructions may be executed, interpreted, and/or otherwise processed by processing logic 120.

Primary storage 130 may be implemented using one or more memory devices that may store information for processing logic 120. The information may include executable instructions that may be executed by processing logic 120. The information may also include data that may be manipulated by processing logic 120. The memory devices may include volatile and/or non-volatile memory devices.

OS 132 may be a conventional operating system that may implement various conventional operating system functions. These functions may include, for example, (1) scheduling one or more portions of APP 134 to run on (e.g., be executed by) the processing logic 120, (2) managing primary storage 130, and (3) controlling access to various components in computing device 100 (e.g., input devices 160, output devices 170, communication interfaces 180, secondary storage 150) and information received and/or transmitted by these components.

Examples of operating systems that may be used to implement OS 132 may include the Linux operating system, Microsoft Windows operating system, the Symbian operating system, Mac OS operating system, iOS operating system, Chrome OS and the Android operating system. A distribution of the Linux operating system that may be used is Red Hat Linux available from Red Hat Corporation, Raleigh, N.C. Versions of the Microsoft Windows operating system that may be used include Microsoft Windows Mobile, Microsoft Windows 8.1, Microsoft Windows 8, Microsoft Windows 7, Microsoft Windows Vista, and Microsoft Windows XP operating systems available from Microsoft Inc., Redmond, Wash. The Symbian operating system is available from Accenture PLC, Dublin, Ireland. The Mac OS and iOS operating systems are available from Apple, Inc., Cupertino, Calif. The Chrome OS and Android operating systems are available from Google, Inc., Menlo Park, Calif.

APP 134 may be a software application that may run (execute) under control of OS 132 on computing device 100. APP 134 and/or OS 132 may contain provisions for processing transactions that may involve storing information in secondary storage 150. These provisions may be implemented using data and/or computer-executable instructions contained in APP 134 and/or OS 132.

Secondary storage 150 may include one or more storage devices, such as storage device 200. The storage devices may be accessible to processing logic 120 via I/O bus 110. The storage devices may store information (e.g., data, computer-executable instructions). The information may be executed, interpreted, manipulated, and/or otherwise processed by processing logic 120. One or more of the storage devices may implement one or more embodiments of the invention.

The storage devices may be volatile or non-volatile. Storage devices that may be included in secondary storage 150 may include, for example, magnetic disk drives, optical disk drives, random-access memory (RAM) disk drives, flash drives, thumb drives, SSDs, hybrid drives, and/or other storage devices. The information may be stored on one or more non-transitory tangible computer-readable media contained in the storage devices. Examples of non-transitory tangible computer-readable media that may be contained in the storage devices may include magnetic discs, optical discs, volatile memory devices, and or non-volatile memory devices.

Storage device 200 may be a storage device that may store information for computing device 100. For example, storage device 200 may be a hard disk drive, an optical drive, a flash drive, an SSD, a hybrid drive, or some other type of storage device that may store information for computing device 100.

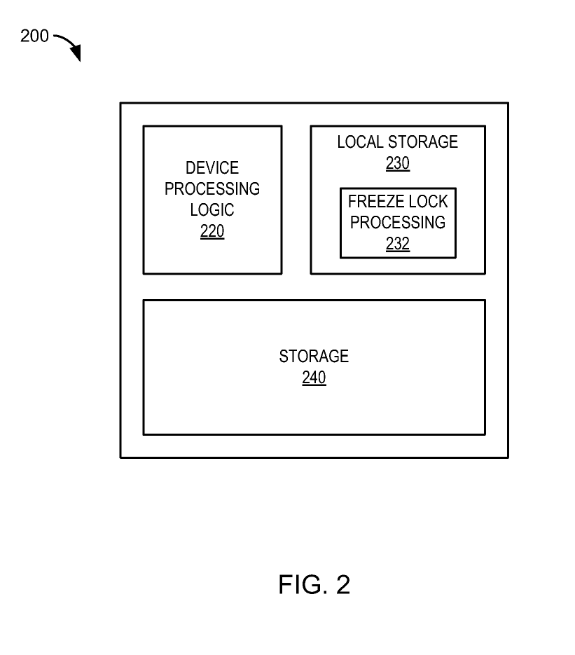

FIG. 2 illustrates an example embodiment of storage device 200. Referring to FIG. 2, storage device 200 may include device processing logic 220, local storage 230, and a storage 240.

The device processing logic 220 may interpret, execute, manipulate and/or otherwise process information contained in local storage 230. Device processing logic 220 may include some combination of one or more processors, microprocessors, FPGAs, ASIPs, ASICs, CPLDs, and/or other types of processing logic that may interpret, execute, manipulate, and/or otherwise process the information.

Local storage 230 may include a tangible non-transitory volatile and/or non-volatile storage that may be used to store the information for device processing logic 220. The information may include data and/or computer-executable instructions that may be associated with an operation of storage device 200.

Local storage 230 may include information that may be used to implement a freeze lock feature for storage device 200. The freeze lock feature may freeze lock storage device 200 and cause storage device 200 to decline processing, for example, security-related commands.

For example, storage device 200 may provide support for the SECURITY FREEZE LOCK command as defined by the ATA standard. Local storage 230 may include executable code (e.g., firmware) that when executed by device processing logic 220 may implement functionality associated with the SECURITY FREEZE LOCK command such as described above. This functionality may include, for example, causing storage device 200 to no longer process security-related commands (e.g., SECURITY SET PASSWORD command) until the storage device 200 is reset or power cycled.

Storage 240 may include provisions for storing information for storage device 200. Storage 240 may contain, for example, one or more volatile and/or non-volatile memory devices that may be used to store the information. Examples of memory devices that may be used include, but are not limited to, flash memory and DRAM devices.

Alternatively or in addition to, storage 240 may include one or more rotating disks (platters) that may be used to store the information. Here, the platters may include a coating that may enable the information to be stored, for example, magnetically.

Referring now to FIGS. 1 and 2, processing logic 120 may execute one or more computer-executable instructions contained in primary storage 130. The executed instructions may generate one or more commands that may be used to perform various functions associated with storage device 200. These functions may include, for example, storing information into and/or retrieving information from storage 240.

The commands may be sent to storage device 200 via bus 110. Storage device 200 may receive the commands and process them. Here, processing a command may include executing various computer-executable instructions stored in local storage 230 to perform one or more operations associated with the command.

For example, suppose an operation associated with a command includes retrieving information from storage 240. Device processing logic 220 may process the command by executing one or more instructions contained in local storage 230 to read the information from storage 240. After reading the information from storage 240, device processing logic 220 may execute one or more instructions in local storage 230 to transfer the information via bus 110 to processing logic 120.

In another example, suppose storage device 200 is an SSD and bus 110 is a PCIe interface. Storage device 200 may be compliant with the NVMe specification. This compliance may include supporting various vendor specific commands such as, for example, SECURITY SEND and SECURITY RECEIVE. Device processing logic 220 may receive one or more of these vendor specific commands via bus 110 and process the received commands. Here, processing may include performing various operations that may be defined by a vendor of storage device 200.

Freeze lock processing 232 may include logic to automatically freeze lock storage device 200. For example, freeze lock processing 232 may include one or more computer-executable instructions that when executed by device processing logic 220 may determine whether storage device 200 should be automatically freeze locked and, if so, automatically freeze lock storage device 200, thereby placing storage device 200 in a frozen security state.

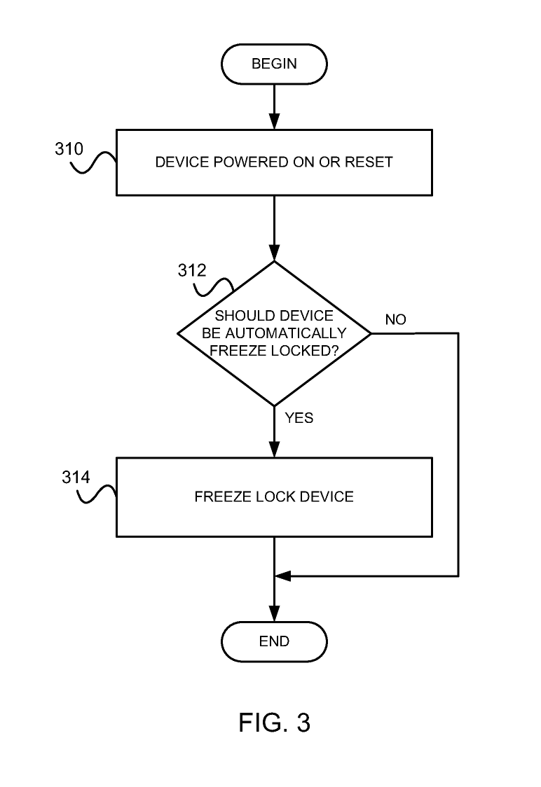

FIG. 3 illustrates a flow diagram of example acts that may be used to automatically freeze lock a storage device such as, for example, storage device 200. Referring to FIG. 3, at block 310 the storage device is powered on or reset. Powering on the storage device may include applying power to the storage device. Resetting the storage device may include forcing the device to a known state. The device may be forced to a known state, for example, by issuing a command to the storage device that causes the storage device to enter the known state.

For example, a command may be issued to storage device 200 to reset the storage device 200. Storage device 200 may receive the command and enter a predefined state which may be defined as an initial state for the storage device 200. Entering the predefined known state may include, for example, device processing logic 220 executing code contained in local storage 230 to initialize various state in storage device 200 to a known state. In another example, power may be applied to storage device 200 and device processing logic 220 may execute code that may initialize storage device 200 to a predefined known state after power-up.

At block 312, a check is performed to determine whether the storage device should be automatically freeze locked. The determination may be made, for example, based on whether certain criteria has been met. The determination may, for example, generate a result. The result may be used, for example, to identify an action to be taken after the determination.

If at block 312 it is determined that the storage device should be automatically freeze locked, at block 314, the storage device may be automatically freeze locked. “Automatically” here may refer to the storage device 200 entering a freeze lock state autonomously (i.e., on its own accord) and without outside intervention (e.g., without having to receive a command from processing logic 120).

For example, freeze lock processing 232 may include one or more executable instructions that when executed by device processing logic 220 after storage device has been powered on or reset. The instructions when executed may determine whether storage device 200 should be automatically freeze locked. The instructions when executed may also cause storage device 200 to automatically enter a frozen security state based on a result of the determination.

Criteria that may be used to determine whether the storage device should be automatically freeze locked may be time based. For example, a timer may be implemented in storage device 200 that is used to determine whether storage device 200 should be freeze locked. If the timer reaches a predetermined value before certain criteria is met to suspend the timer, the device processing logic 220 may place storage device 200 in a frozen security state.

For example, the timer may be reset to zero and periodically counted up towards the predetermined value. If the counter reaches the predetermined value before criteria is met to suspend the timer (e.g., a freeze lock command is received by the storage device 200 from an outside source (e.g., processing logic 120)), the device processing logic 220 may place storage device 200 into a frozen security state.

In another example, the timer may be preset with a value and periodically counted down towards the predetermined value (e.g., zero). If the counter reaches the predetermined value before criteria is met to suspend the timer (e.g., a freeze lock command is received by the storage device 200 from an outside source), the device processing logic 220 may automatically place the storage device 200 into a frozen security state.

In the above examples, certain events may trigger starting the timer. For example, the timer may be started shortly after the storage device 200 is powered up or reset. In another example, the timer may be started after any command or a certain type of command (e.g., a security-related command) has been received by the storage device 200.

Other criteria that may be used to determine whether the storage device should be placed in a frozen security state may include receipt of certain commands, certain types of commands, and/or command sequences. For example, in computing device 100, device processing logic 120 may issue various commands to storage device 200. These commands may include certain administrative commands that may be used to set up, for example, I/O queues associated with storage device 200. Here, for example, if storage device 200 receives certain administrative commands or certain sequences of commands that include certain administrative commands, device processing logic 220 may place storage device 200 in a frozen security state. In other examples, device processing logic 220 may place storage device 200 in a frozen security state after receiving certain I/O commands (e.g., read, write, and/or seek commands), certain vendor specific commands (e.g., SECURITY SEND, SECURITY RECEIVE), and/or certain sequences thereof.

Still other criteria that may be used to determine whether the storage device should be placed in a frozen security state may include, for example, non-receipt of specific commands, certain types of commands, and/or command sequences. For example, in computing device 100, if storage device 200 fails to receive certain security commands (e.g., a freeze lock command) before certain events (e.g., before I/O queues for storage device 200 are set up), device processing logic 220 may place storage device 200 in a frozen security state.

The foregoing description of embodiments is intended to provide illustration and description, but is not intended to be exhaustive or to limit the invention to the precise form disclosed. Modifications and variations are possible in light of the above teachings or may be acquired from practice of the invention. For example, while a series of acts has been described above with respect to FIG. 3, the order of the acts may be modified in other implementations. Further, non-dependent acts may be performed in parallel.

Also, the term “user”, as used herein, is intended to be broadly interpreted to include, for example, a computing device (e.g., fixed computing device, mobile computing device) or a user of a computing device, unless otherwise stated.

It will be apparent that one or more embodiments, described herein, may be implemented in many different forms of software and/or hardware. Software code and/or specialized hardware used to implement embodiments described herein is not limiting of the invention. Thus, the operation and behavior of embodiments were described without reference to the specific software code and/or specialized hardware—it being understood that one would be able to design software and/or hardware to implement the embodiments based on the description herein.

Further, certain features of the invention may be implemented using computer-executable instructions that may be executed by processing logic such as, for example, device processing logic 220. The computer-executable instructions may be stored on one or more non-transitory tangible computer-readable storage media. The media may be volatile or non-volatile and may include, for example, DRAM, SRAM, flash memories, removable disks, non-removable disks, and so on.

No element, act, or instruction used herein should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

It is intended that the invention not be limited to the particular embodiments disclosed above, but that the invention will include any and all particular embodiments and equivalents falling within the scope of the following appended claims.

What is claimed is:

1. A method comprising:
determining at a storage device whether the storage device should automatically enter a frozen security state, the determining being based on one or more criteria associated with the storage device, the storage device declines processing one or more security-related commands while the storage device is in the frozen security state; and
at the storage device, automatically entering the frozen security state based on a result of the determination.

2. The method of claim 1, wherein the storage device includes device processing logic that makes the determination.

3. The method of claim 1, wherein the storage device remains in the frozen security state until the storage device is power cycled or reset.

4. The method of claim 1, wherein the criteria is time based.

5. The method of claim 1, wherein the criteria includes the storage device receiving a predefined type of command.

6. The method of claim 1, wherein the criteria includes the storage device receiving a predefined sequence of commands.

7. The method of claim 1, wherein the storage device maintains a timer and wherein the criteria includes the timer reaching a predetermined value.

8. The method of claim 1, wherein the criteria includes the storage device not receiving a predefined sequence of commands.

9. The method of claim 1, wherein the criteria includes the storage device not receiving a predefined type of command.

10. The method of claim 1, wherein the criteria includes the storage device having received a command to establish at least one input/output (I/O) queue associated with the storage device.

11. An apparatus comprising:
a storage for storing information for use by a computing device; and
device processing logic for:
determining whether the apparatus should automatically enter a frozen security state, the determining being based on one or more criteria associated with the apparatus, the apparatus declines processing one or more security-related commands while in the frozen security state; and
automatically entering the frozen security state based on a result of the determination.

12. The apparatus of claim 11, wherein the apparatus remains in the frozen security state until the apparatus is power cycled or reset.

13. The apparatus of claim 11, wherein the criteria is time based.

14. The apparatus of claim 11, wherein the criteria includes the device processing logic receiving a predefined type of command from processing logic associated with a computing device.

15. The apparatus of claim 11, wherein the criteria includes the device processing logic receiving a predefined sequence of commands from processing logic associated with a computing device.

16. The apparatus of claim 11, wherein the device processing logic maintains a timer and wherein the criteria includes the timer reaching a predetermined value.

17. The apparatus of claim 11, wherein the criteria includes the device processing logic not receiving a predefined sequence of commands from processing logic associated with a computing device.

18. The apparatus of claim 11, wherein the criteria includes the device processing logic not receiving a predefined type of command from processing logic associated with a computing device.

19. The apparatus of claim 11, wherein the criteria includes the device processing logic having received a command to establish at least one input/output (I/O) queue associated with the apparatus.

20. One or more tangible non-transitory computer-readable mediums storing executable instructions for execution by processing logic, the medium storing:
one or more instructions for determining at a storage device whether the storage device should automatically enter a frozen security state, the determining being based on one or more criteria associated with the storage device; and
one or more instructions for, at the storage device, automatically entering the frozen security state based on a result of the determination.

21. The media of claim 20, wherein the criteria is time based.

22. The media of claim 20, wherein the criteria includes the storage device receiving a predefined type of command, or the storage device receiving a predefined sequence of commands.

23. The media of claim 20, wherein the storage device maintains a timer and wherein the criteria includes the timer reaching a predetermined value.

24. The media of claim 20, wherein the criteria includes the storage device not receiving a predefined sequence of commands, or the criteria includes the storage device not receiving a predefined type of command.

25. The media of claim 20, wherein the criteria includes the storage device having received a command to establish at least one input/output (I/O) queue associated with the storage device.
